(19) United States
(12) Patent Application Publication
(10) Pub. No.: US 2004/0095550 A1
(43) Pub. Date: May 20, 2004

(54) Polarized illumination system and liquid crystal display device

(76) Inventor: Shu-Lin Tai, Santa Clara, CA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/411,541

(22) Filed: Apr. 9, 2003

(30) Foreign Application Priority Data
Nov. 15, 2002 (TW) 91218340

(51) Int. Cl. G02F 1/1335

(52) U.S. Cl. 349/194

(57) ABSTRACT

A polarized illumination system (10) in accordance with the present invention includes an illumination device (1) for emitting light beams and a polarizing device (2) aligned with the illumination device. The polarizing device has a first micro lens array (21), a second micro lens array (22), a birefringent crystal (23), and a plurality of half wave retardation plates (24) arranged in order. The birefringent crystal splits light beams into two, orthogonally polarized components, and the half wave retardation plates convert the polarization state of one of those components to match the state of the other component. The half wave retardation plates are attached to one side of the birefringent crystal. The structure of the polarized illumination system has low cost and high light utilization efficiency.

### BACKGROUND OF THE INVENTION

1. Field of the Invention

The invention relates generally to a liquid crystal display (LCD) and an illumination system for use in the LCD, and particularly to a backlight system for the liquid crystal display.

2. The Related Arts

In a current liquid crystal display (LCD), light beams from a backlight system or an edge light system must first be polarized before being used for illuminating the LCD. Current backlight or edge light systems use a plurality of fluorescent tubes to emit light beams. Since such light beams are unpolarized, a polarizer is required. The polarizer absorbs a first polarized component of the light beams and transmits a second, orthogonally polarized component. The second, orthogonally polarized component is transmitted to the LCD. Thus, approximately 50% of the light emitted by the backlight or edge light system is lost before reaching the LCD.

In order to improve efficiency, a device has been proposed in which the first polarized component is converted to match the polarization state of the second, orthogonally polarized component. The first polarized component is then also suitable for illuminating the LCD.

Referring to FIG. 5, U.S. Pat. No. 5,808,709 discloses an illuminator 70 that includes a light source 71 coupled with a light pipe 75 and a first reflector 72 positioned behind the light source 71 for reflecting substantially all of the light beams emitted by the light source 71 towards the light pipe 75. The light pipe 75 includes a first surface 751 upon which an anisotropic layer 74 is provided. The anisotropic layer 74 has a first refractive index equal to that of the light pipe 75 and a second refractive index less than that of the light pipe 75. A second reflector 73 is positioned adjacent to the anisotropic layer 74 so as to reflect light beams transmitted by the anisotropic layer 74 back through the anisotropic layer 74 and into the light pipe 75. A second surface 752 of the light pipe 75 includes a first retarder 76, a second retarder 77, and a weak polarization preserving diffuser 78.

In use, unpolarized light beams emitted by the light source 71 enter the light pipe 75 and are transmitted between the first surface 751 and the second surface 752. Because the refractive index of the light pipe 75 is equal to the first refractive index of the anisotropic layer 74, substantially no light of a first polarized component, denoted by the dot in FIG. 5, is reflected at a boundary between the light pipe 75 and the anisotropic layer 74. Thus substantially all of the light beams with the first polarization are reflected by the reflector 73 and transmit towards the LCD. Since the refractive index of the light pipe 75 is greater than the second refractive index of the anisotropic layer 74, a part of the light beams with a second, orthogonally polarized component, denoted by double-headed arrows in FIG. 5, is reflected at the boundary between the light pipe 75 and the anisotropic layer 74. The light pipe 75 is likely to be slightly anisotropic and hence, as the light beams bounce along the light pipe 75, polarization conversion occurs. Thus, eventually, substantially all of the light of the second polarized component is converted to a polarization matching that of the first polarized component and is reflected out of the light pipe 75 by the reflector 73.

The conventional illuminator 70 has some disadvantages. First, a large amount of the light beams generated by the light source 71 are usually lost in bouncing along the light pipe 75 or are absorbed by the first retarder 76 and the second retarder 77. Second, the illuminator 70 comprises a plurality of optical elements, such as the light pipe 75, the first retarder 76, the second retarder 77 and the weak polarization preserving diffuser 78, which makes it high in cost.

Therefore, an improved polarized illumination system which overcomes the above-described disadvantages of the conventional illuminator is desired.

### SUMMARY OF THE INVENTION

An object of the present invention is to provide a polarized illumination system which is highly efficient in light utilization.

Another object of the present invention is to provide a polarized illumination system which is low in cost.

A polarized illumination system in accordance with the present invention comprises an illumination device for emitting light beams and a polarizing device aligned with the illumination device. The polarizing device has a first micro lens array, a second micro lens array, a birefringent crystal and a plurality of half wave retardation plates, which are arranged in order. The half wave retardation plates are attached to one side of the birefringent crystal. The structure of the polarized illumination system has a high light utilization efficiency and low cost.

Furthermore, a liquid crystal display incorporates the above mentioned polarized illumination system by positioning the system at a rear surface of an LCD panel.

Other objects, advantages, and novel features of the present invention will become more apparent from the following detailed description when taken in conjunction with the accompanying drawings.

### BRIEF DESCRIPTION OF THE DRAWINGS

FIG. 1 is a schematic diagram of a polarized illumination system according to the present invention;

FIG. 2 is an essential optical paths diagram of the polarized illumination system in FIG. 1;

FIG. 3 is an essential optical paths diagram of a second embodiment of a polarized illumination system of the present invention.

FIG. 4 is a schematic diagram of an LCD device incorporating the polarized illumination system of FIG. 1; and

FIG. 5 is a prior art illuminator.

### DETAILED DESCRIPTION OF THE INVENTION

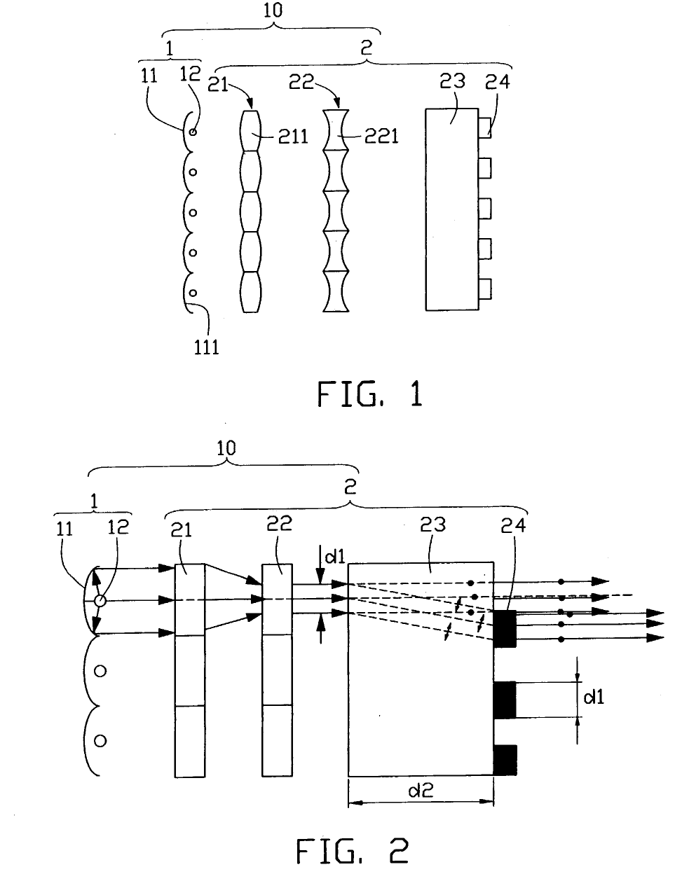

Referring to FIG. 1, a polarized illumination system 10 is used to illuminate a liquid crystal display device. The polarized illumination system 10 comprises an illumination device 1 for emitting light and a polarizing device 2.

The illumination device 1 includes a plurality of concave mirrors 11 and a plurality of light sources 12, wherein each light source 12 is paired with one corresponding concave mirror 11. The concave mirrors 11 have a reflective coating 111 thereon, which coating has a reflective index greater than 98%. Thus, almost all the light emitted by the light sources 12 are reflected and transmitted to the polarizing device 2.

The polarizing device 2 includes a first micro lens array 21, a second micro lens array 22, a birefringent crystal 23 and a plurality of half wave retardation plates 24, which are arranged in order. The first micro lens array 21 comprises a plurality of convex lenses 211 and the second micro lens array 22 comprises a plurality of concave lenses 221. Each convex lens 211 and each concave lens 221 has a diameter of 10˜300 micron and can be formed using LIGA (a German acronym meaning Lithographie Galvanoformung und Abformung). The first and second micro lens arrays 21, 22 are arranged parallel to one another, with each convex lens 211 of the first micro lens array 21 being arranged opposite a concave lens 221 of the second micro lens array 22. The birefringent crystal 23 is opposite the second micro lens array 22, and can be a walk-off crystal, such as a YVO4 crystal or a LiNbO3 crystal. The half wave retardation plates 24 are attached to one side of the birefringent crystal 23 by epoxy resin and are positioned to each have a fixed positional relation corresponding with a concave lens of the second micro lens array 22.

When assembled, referring to FIG. 2, the light sources 12 of the illumination device 1 are positioned close to the first micro lens array 21 of the polarizing device 2, wherein each light source 12 corresponds to one convex lens 211 of the first micro lens array 21 and one concave lens 221 of the second micro lens array 22. The convex lens 211 converges the light rays emitted by the light source 12 and the concave lens 221 collimates the light rays from the convex lens 211 into a beam of parallel rays with a certain beam width (d1). The birefringent crystal 23 is used to split the light beams into two polarized components. A thickness (d2) of the birefringent crystal is chosen according to the beam width (d1), so that, when the two polarized components exit from the birefringent crystal 23, no area of overlap between the two polarized components exists. The half wave retardation plates 24 are arranged at intervals such that a length of the half wave retardation plates 24 and a distance between them are equal to the beam width (d1).

In operation, randomly unpolarized light rays are emitted by the light sources 12 and are transmitted to the corresponding convex lenses 211 of the first micro lens array 21, which transmits the convergent rays to the corresponding concave lenses 221 of the second micro lens array 22, which collimates the light rays into beams each having width (d1). Then, the collimated beams enter into the birefringent crystal 23, which separates each beam into two orthogonally polarized components, each having the width (d1), and being designated a first polarized beam and a second polarized beam. The first polarized beam, denoted by dots, passes directly through the birefringent crystal 23 without changing in direction. The second polarized beam, denoted by double-headed arrows, passes sequentially through the birefringent crystal 23 and a corresponding half wave retardation plate 24. The half wave retardation plate 24 rotates the polarization state of the second polarized beam by 90°, thus converting its polarization state to match that of the first polarized beam. The length of the half wave retardation plate 24 is equal to the width (d1) of the second polarized beam. Thus, all the second polarized beams undergo a change in polarization state to match the polarization state of the first polarized beams. Therefore, all the output light beams have the same polarization state, and can then be transmitted to an LCD.

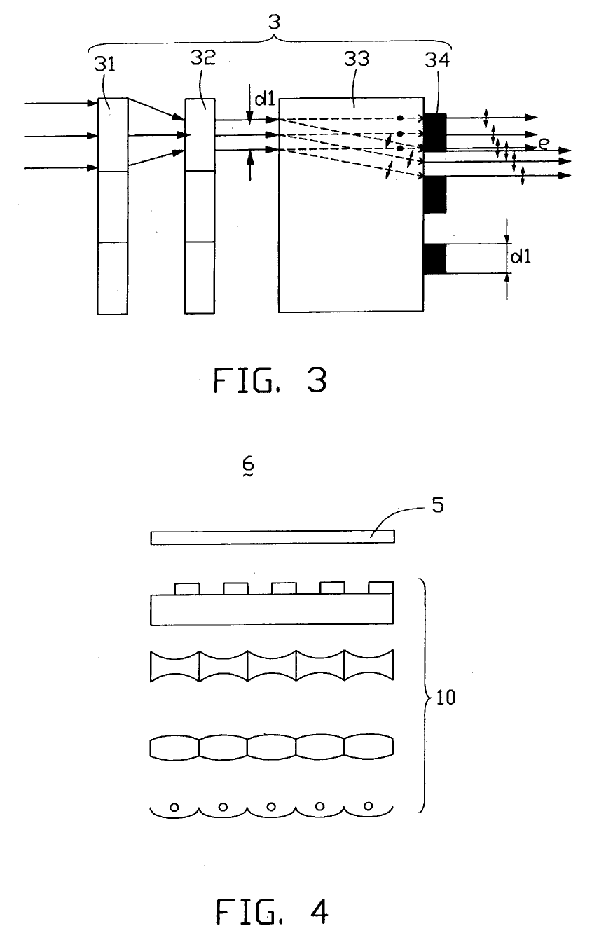

FIG. 3 shows an alternative embodiment of the present invention. The polarizing device 3 is similar to the polarizing device 2, in that the polarizing device 3 comprises a first micro lens array 31, a second micro lens array 32, a birefringent crystal 33 and a plurality of half retardation plates 34 attached to one side of the birefringent crystal 33 by epoxy resin. The half wave retardation plates 34 rotate the polarization state of the first polarized beams, denoted by the dots, thus converting their polarization states to match that of the second polarized beam. In operation, the collimated beams having width (d1) enter into the birefringent crystal 33 and are separated into two orthogonally polarized components, first polarized beams and second polarized beams. The first polarized beams, denoted by dots, pass through the half wave retardation plates 34 and have their polarization states converted to match that of the second polarized beams. The second polarized beams pass through the birefringent crystal 33 at an angle and emerge parallel to the first polarized beams. A length of the half wave retardation plates 34 is equal to the width (d1); therefore, all of the rays of the first polarized beams are converted. Therefore, all the output light beams have the same polarization state and can be transmitted to an LCD.

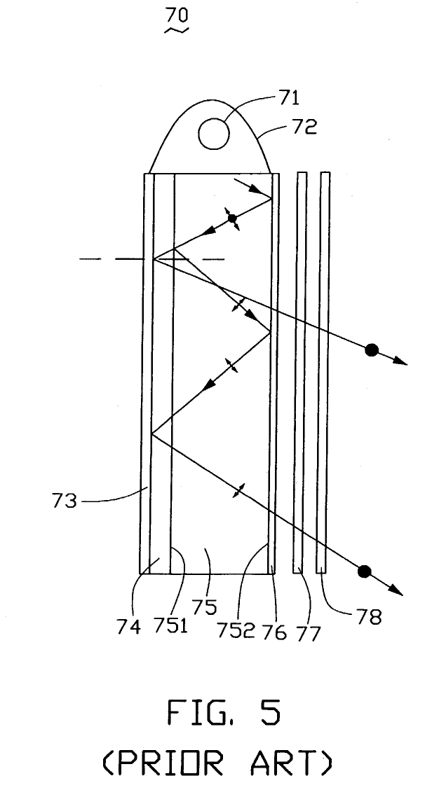

FIG. 4 shows an LCD device 6, wherein the polarized illumination system 10 is used in conjunction with a liquid crystal display panel 5. The polarized illumination system 10 is arranged to illuminate the liquid crystal display panel 5 as a backlight system.

Advantages of the described embodiments over the prior art include the following. First, the structure of the polarized illumination system 10 is highly efficient in light utilization. Second, the number of optical elements is reduced, resulting in a system which has a low cost.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A polarized illumination system for a display device comprising:
an illumination device for emitting light beams;
a polarizing device aligning with the illumination device, the polarizing device having a first micro lens array, a second micro lens array, a birefringent crystal, and a plurality of half wave retardation plates;
wherein the first micro lens array, the second micro lens array, the birefringent crystal, and the half wave retardation plates are arranged in order, and the half wave retardation plates are fixed on one side of the birefringent crystal in a predetermined, fixed relation to the second micro lens array.

2. The polarized illumination system as claimed in claim 1, wherein the first micro lens array comprises a plurality of convex lenses.

3. The polarized illumination system as claimed in claim 1, wherein the second micro lens array comprises a plurality of concave lenses.

4. The polarized illumination system as claimed in claim 1, wherein the plurality of half wave retardation plates is arranged at intervals.

5. The polarized illumination system as claimed in claim 4, wherein a distance between adjacent half wave retardation plates is equal to a length of each half wave retardation plate.

6. A liquid crystal display comprising:
a liquid crystal display panel;
a polarized illumination system aligned with the liquid crystal display panel for illuminating it, the polarized illumination system comprising:
an illumination device for emitting light beams;
a polarizing device aligning with the illumination device, the polarizing device having a first micro lens array, a second micro lens array, a birefringent crystal, and a plurality of half wave retardation plates;
wherein the first micro lens array, the second micro lens array, the birefringent crystal and the half wave retardation plates are arranged in order, and the half wave retardation plates are fixed on one side of the birefringent crystal in a predetermined, fixed relation to the second micro lens array.

7. The liquid crystal display as claimed in claim 6, wherein the first micro lens array comprises a plurality of convex lenses.

8. The liquid crystal display as claimed in claim 6, wherein the second micro lens array comprises a plurality of concave lenses.

9. The liquid crystal display as claimed in claim 6, wherein the plurality of half wave retardation plates is arranged at intervals.

10. The liquid crystal display as claimed in claim 9, wherein a distance between adjacent half wave retardation plates is equal to a length of each half wave retardation plate.

11. A polarized illumination system for a display device comprising:
a plurality of illumination devices emitting light beams therefrom; and
a polarizing device arranged in an array manner along a first direction, each unit of said polarizing device aligned with the corresponding light beams along a second direction perpendicular to said first direction, respectively, said polarizing device including a set of lens assembly for collimating the corresponding light beams from the illumination devices in a parallel relation, and a birefringent crystal with an array of spaced half wave retardation plates located on thereof one side away from said set of lens assembly; wherein
the collimated light beams is dimensioned with a width which is close to a height of the corresponding half wave retardation plate.

12. The system as claimed in claim 11, wherein said light beams leaving the unit of the system, are all of a same polarization.
